(19) United States
(12) Patent Application Publication
(10) Pub. No.: US 2019/0073001 A1
(43) Pub. Date: Mar. 7, 2019

(54) DISPLAY HAVING AT LEAST ONE PORTION PROVIDED AS SPHERICALLY-SHAPED PORTION AND ELECTRONIC DEVICE COMPRISING SAME

(71) Applicant: Samsung Electronics Co., Ltd., Suwon-si, Gyeonggi-do (KR)

(72) Inventors: Jong Hae KIM, Seoul (KR); Byeong Cheol KIM, Suwon-si (KR); Tae Sung KIM, Seongnam-si (KR); Sang Ryeol CHA, Suwon-si (KR); Sung Ho AHN, Seoul (KR)

(21) Appl. No.: 16/083,715

(22) PCT Filed: Mar. 9, 2017
(86) PCT No.: PCT/KR2017/002588

§ 371 Date: Sep. 10, 2018

(30) Foreign Application Priority Data
Mar. 10, 2016 (KR) 10-2016-0029121

(51) Int. Cl. G06F 1/16; H04M 1/02; G06F 3/041; G02F 1/1335

(52) U.S. Cl. CPC G06F 1/1637; H04M 1/0266; G02F 2001/13356; G06F 3/0412; G02F 1/133528; H04M 1/0277

(57) ABSTRACT

Disclosed are a display and an electronic device including the display, which includes a panel device outputting a specified image using a power applied thereto and an external protective layer having a specified transparency and disposed on the panel device to protect the panel layer. The external protective layer is provided such that a thickness of a center portion of an upper portion surface is greater than a thickness of a peripheral portion, and the panel device includes a panel layer outputting the specified image in response to the power applied thereto and an adhesive layer adhering the panel layer to a lower portion of the external protective layer. Other various embodiments identified in the specification are also possible.

### TECHNICAL FIELD

Various embodiments relate to a display with at least a portion provided as a portion of a spherical shape.

### BACKGROUND ART

Conventional mobile electronic devices have a quadrangular shape in general.

### DISCLOSURE

### Technical Problem

Since the electronic device having the quadrangular shape includes at least one corner, a specific portion (e.g., the corner) is relatively easily damaged compared with another portion when an external impact is applied to the electronic device.

Various embodiments provide a display with at least a portion provided as a portion of a spherical shape or a dome shape and an electronic device employing the same.

### Technical Solution

An electronic device includes a panel device outputting a specified image using a power applied thereto, an external protective layer having a specified transparency and disposed on the panel device to protect the panel device, and a case disposed under the external protective layer and receiving the panel device mounted thereon. The external protective layer is provided such that a thickness of a center portion of an upper portion surface is greater than a thickness of a peripheral portion, and the panel device includes a panel layer outputting the specified image in response to the power applied thereto and an adhesive layer adhering the panel layer to a lower portion of the external protective layer.

A display includes a panel device outputting a specified image using a power applied thereto and an external protective layer having a specified transparency and disposed on the panel device to protect the panel device. The external protective layer is provided such that a thickness of a center portion of an upper portion surface is greater than a thickness of a peripheral portion, and the panel device includes a panel layer outputting the specified image in response to the power applied thereto and an adhesive layer adhering the panel layer to a lower portion of the external protective layer.

Other aspects, advantages, and salient features of the disclosure will become apparent to those skilled in the art from the following detailed description, which, taken in conjunction with the annexed drawings, discloses various embodiments of the present disclosure.

### Advantageous Effects

Various embodiments as described above may have a circular edge and provided in a partially spherical shape of a dome shape, and thus various embodiments may provide a strong and stable structure against external impacts.

### DESCRIPTION OF DRAWINGS

FIG. 1 is a view showing an example of a cross-section of an electronic device according to an exemplary embodiment of the present disclosure.

FIG. 2 is a view showing a light irradiation angle of a display according to an exemplary embodiment of the present disclosure.

FIG. 3 is a view showing an example of a structure of a display according to an exemplary embodiment of the present disclosure.

FIG. 4 is a view showing an example of a display according to an exemplary embodiment of the present disclosure.

FIG. 5 is a view showing an example of a distortion correction of a display according to an exemplary embodiment of the present disclosure.

FIG. 6 is a view showing an example of a distortion correction calculation of a display according to an exemplary embodiment of the present disclosure.

FIG. 7 is a view showing an example of a manufacturing process of a display according to an exemplary embodiment of the present disclosure.

FIG. 8 is a view showing an example of a crease prevention structure of a display according to an exemplary embodiment of the present disclosure.

FIGS. 9A and 9B are views showing other examples of a crease prevention structure of a display according to an exemplary embodiment of the present disclosure.

FIG. 10 is a view explaining a process on crease in a structure of a display according to an exemplary embodiment of the present disclosure.

FIG. 11A is a view showing a first example of various shapes of a display according to an exemplary embodiment of the present disclosure.

FIG. 11B is a view showing a second example of various shapes of a display according to an exemplary embodiment of the present disclosure.

FIG. 11C is a view showing a third example of various shapes of a display according to an exemplary embodiment of the present disclosure.

FIG. 11D is a view showing a fourth example of various shapes of a display according to an exemplary embodiment of the present disclosure.

FIG. 12A is a view showing an example of an exterior of an electronic device to which a display is applied according to an exemplary embodiment of the present disclosure.

FIG. 12B is a view showing another example of an exterior of an electronic device to which a display is applied according to an exemplary embodiment of the present disclosure.

FIG. 13 is a view showing an example of an operating environment of an electronic device according to an exemplary embodiment of the present disclosure.

FIG. 14 is a block diagram showing an electronic device according to various embodiments.

FIG. 15 is a block diagram showing a program module according to various embodiments.

### MODE FOR INVENTION

Hereinafter, various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar components may be marked by similar reference numerals.

In the present disclosure, the expressions “have”, “may have”, “include” and “comprise”, or “may include” and “may comprise” used herein indicate existence of corresponding features (e.g., components such as numeric values, functions, operations, or parts) but do not exclude presence of additional features.

In the present disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in the present disclosure may be used to refer to various components regardless of the order and/or the priority and to distinguish the relevant components from other components, but do not limit the components. For example, “a first user device” and “a second user device” indicate different user devices regardless of the order or priority. For example, without departing the scope of the present disclosure, a first component may be referred to as a second component, and similarly, a second component may be referred to as a first component.

It will be understood that when an component (e.g., a first component) is referred to as being “(operatively or communicatively) coupled with/to” or “connected to” another component (e.g., a second component), it may be directly coupled with/to or connected to the other component or an intervening component (e.g., a third component) may be present. In contrast, when an component (e.g., a first component) is referred to as being “directly coupled with/to” or “directly connected to” another component (e.g., a second component), it should be understood that there are no intervening component (e.g., a third component).

According to the situation, the expression “configured to” used in the present disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other parts. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in the present disclosure are used to describe specified embodiments and are not intended to limit the scope of the present disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of the present disclosure. In some cases, even if terms are terms which are defined in the present disclosure, they may not be interpreted to exclude embodiments of the present disclosure.

An electronic device according to various embodiments of the present disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to various embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or a bio-implantable type (e.g., an implantable circuit).

According to various embodiments, the electronic device may be a home appliance. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or Play Station™), electronic dictionaries, electronic keys, camcorders, electronic picture frames, and the like.

According to another embodiment, an electronic device may include at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, Global Navigation Satellite System (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, automated teller machines (ATMs), points of sales (POSs) of stores, or internet of things (e.g., light bulbs, various sensors, electric or gas meters, sprinkler devices, fire alarms, thermostats, street lamps, toasters, exercise equipment, hot water tanks, heaters, boilers, and the like).

According to an embodiment, the electronic device may include at least one of parts of furniture or buildings/structures, electronic boards, electronic signature receiving devices, projectors, or various measuring instruments (e.g., water meters, electricity meters, gas meters, or wave meters, and the like). According to various embodiments, the electronic device may be one of the above-described devices or a combination thereof. An electronic device according to an embodiment may be a flexible electronic device. Furthermore, an electronic device according to an embodiment of the present disclosure may not be limited to the above-described electronic devices and may include other electronic devices and new electronic devices according to the development of technologies.

Hereinafter, electronic devices according to various embodiments will be described with reference to the accompanying drawings. In the present disclosure, the term “user” may refer to a person who uses an electronic device or may refer to a device (e.g., an artificial intelligence electronic device) that uses the electronic device.

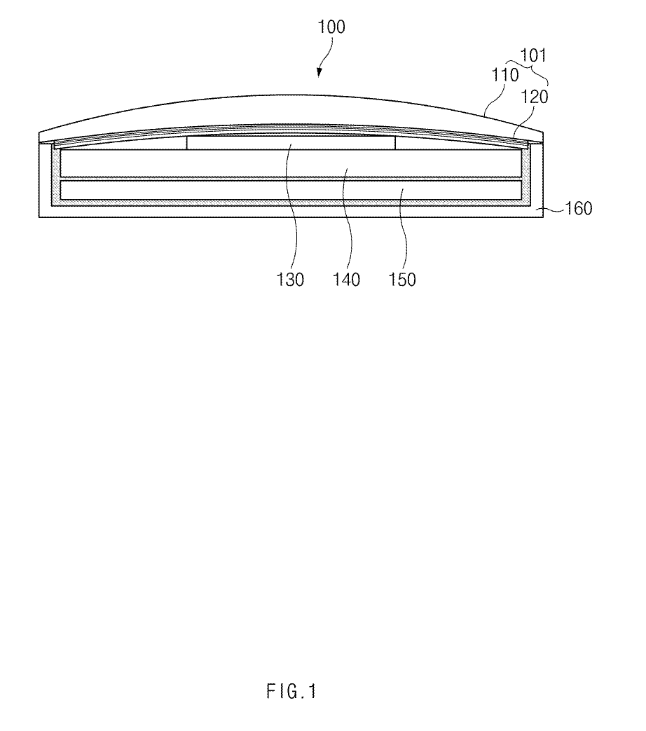

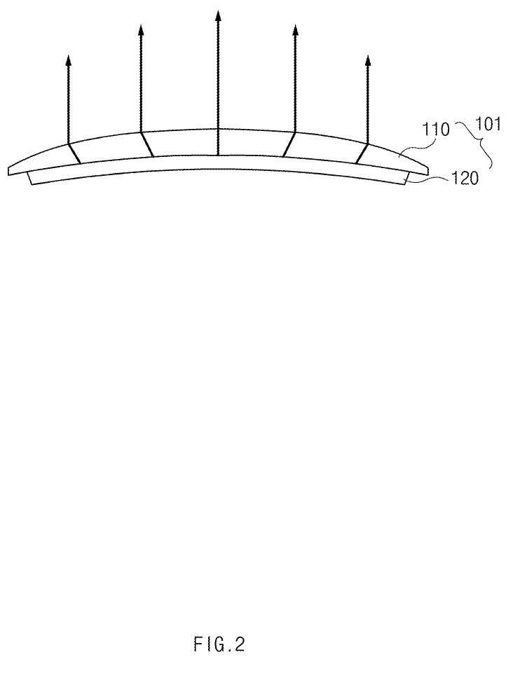

FIG. 1 is a view showing an example of a cross-section of an electronic device according to an exemplary embodiment of the present disclosure, and FIG. 2 is a view showing a light irradiation angle of a display according to an exemplary embodiment of the present disclosure.

Referring to FIG. 1, the electronic device 100 may include a display 101, a power device 130, a sensor device 140, a printed circuit board 150, and a case 160.

The display 101 may include an external protective layer 110 and a panel device 120. The external protective layer 110 (or a window) may include a transparent material (e.g., a glass, plastic, or acryl material). The external protective layer 110 may have an oval shape (or a circular shape) as a whole, and a center portion of an upper portion surface (or a front surface, or an upper surface) may be located at a higher position than (e.g., may be more convex than) a peripheral portion (or an edge, or an edge portion). As another way, the external protective layer 110 may further include a coating portion. A center portion of a lower portion surface (or a rear surface, or a lower surface) of the external protective layer 110 may be located at a higher position than the peripheral portion. The upper portion surface and the lower portion surface of the external protective layer 110 may have the same or similar shape.

According to an embodiment, the external protective layer 110 may have the same or similar thickness as a whole. As another way, a thickness of a specific area of the center portion of the external protective layer 110 may be constant, and a thickness of a specific area of the peripheral portion may vary. For instance, the external protective layer 110 may have a shape in which the thickness gradually decreases from the center portion toward the edge or a shape in which the thickness gradually decreases from the specific area of the center portion toward the edge. As another example, the upper portion surface of the external protective layer 110 may have a curvature different from a curvature of the lower portion surface of the external protective layer 110. For example, when the curvature of the upper portion surface of the external protective layer 110 is greater than the curvature of the lower portion surface, the lower portion surface may be more gently formed than the upper portion surface. A lower portion of the edge of the external protective layer 110 may face sidewalls of the case 160.

The panel device 120 may be disposed under the external protective layer 110. For example, an upper portion surface of the panel device 120 may be disposed to make contact with the lower portion surface of the external protective layer 110. Accordingly, since the upper portion surface of the panel device 120 makes contact with the curved lower portion surface of the external protective layer 110, the upper portion surface of the panel device 120 may be disposed along a curvature similar to the curvature of the lower portion surface of the external protective layer 110. A lower portion surface of the panel device 120 may have a curvature similar to that of the upper portion surface thereof and may be curved. Accordingly, the panel device 120 may be provided with a cavity defined in an inner side with respect to a horizontal surface connecting edges of the panel device 120. An entire size of the panel device 120 may be smaller than an entire size of the external protective layer 110. Thus, a border (or edge) end of the panel device 120 may be disposed inside a border end of the external protective layer 110 under the external protective layer 110. As another way, the edge end of the panel device 120 may be disposed to be aligned with the edge end of the external protective layer 110. The panel device 120 may further include at least one of a panel layer displaying an image, a touch screen panel receiving a touch input by a user, a pressure sensor layer sensing a pressure generated when the touch input occurs by the user, a fingerprint recognition layer (fingerprint sensor area) recognizing a user's fingerprint, an antenna pattern, at least one adhesive layer, or a polarizing layer.

The case 160 may be disposed to surround an edge of the external protective layer 110 of the display 101. As another example, the case 160 may include at least one sidewall supporting a lower portion of the edge (or border) of the external protective layer 110. The case 160 may have a cylindrical shape with a hollow interior and a closed bottom. The power device 130, the sensor device 140, and the printed circuit board 150 may be disposed inside the case 160. The case 160 may be formed of, for example, a metallic material or a non-metallic material. As another example, at least a portion of the case 160 may be formed of the metallic material and may be used as an antenna of a communication module mounted on the printed circuit board 150. According to various embodiments, a touch panel or a pressure sensor may be disposed in at least an area (e.g., a side portion of the case) of the case 160.

The power device 130 may supply a power related to a functional operation of the electronic device 100. The power device 130 may include, for example, a rechargeable battery. The power device 130 may have a shape to effectively fill the cavity defined in and by the panel device 120 curved upwardly. For example, the power device 130 may be a coin-shaped battery with a constant height and an oval or polygonal shape in cross-section. As another way, a portion (e.g., a portion disposed above the sensor device 140) of the power device 130 may have a polygonal cylindrical shape or a cylindrical coin shape with an oval (or circular) shape in cross-section, and the other portion (e.g., a portion disposed above the coin shape) may have a cone shape with a lozenge shape in cross-section. In the embodiment, the cylindrical portion and the cone portion of the power device 130 may be integrally formed with each other. As another example, the power device 130 may have a structure obtained by stacking a plurality of coin-shaped batteries with different diameters from each other one on another. The batteries with different diameters from each other may be electrically connected to each other. In this case, a battery having a relatively large diameter among the batteries may be disposed closer to the structure such as the sensor device 140, and a battery having a relatively small diameter among the batteries may be disposed closer to the panel device 120.

The sensor device 140 may be disposed at at least one of a lower, upper, or side portion of the power device 130. The sensor device 140 may collect various sensor information about the operation of the electronic device 100. The sensor device 140 may include at least one sensor, for example, an image sensor or an illumination sensor. The image sensor or the illumination sensor may sense an illumination of a light applied thereto through the panel device 120 and may transmit the sensed illumination to the printed circuit board 150. According to various embodiments, the sensor device 140 may include an acceleration sensor, a geomagnetic sensor, a position information acquisition sensor, or the like. The sensor device 140 may collect the sensor information in response to a movement of the electronic device 100 and may transmit the collected sensor information to the printed circuit board 150. According to various embodiments, the electronic device 100 may include, alternatively or additionally, an audio device or an electromagnetic induction panel.

Various hardware components (e.g., a processor, a memory, a communication module, and a display control circuit) associated with the control of the electronic device 100 may be mounted on the printed circuit board 150. The communication module mounted on the printed circuit board 150 may use the case of which at least a portion is formed of the metallic material as the antenna. As another way, an antenna used to operate the communication module may be disposed on one side portion of the sensor device 140, on one side portion of the power device 130 (e.g., the battery), or separately between the sensor device 140 and the battery. According to various embodiments, a circuit (e.g., a receiving circuit for a wireless charging and a charging circuit) associated with a wireless charging may be disposed under the printed circuit board 150.

According to various embodiments, at least one of the power device 130, the sensor device 140, or the printed circuit board 150 may have the shape in which a center portion is located at a higher position than a peripheral portion (e.g., a convexly curved shape similar to the curved shape of the panel device 120). As another way, at least a portion of the case 160, for example, a center portion of a bottom surface of the case 160, which faces the printed circuit board 150, may be convexly curved upward.

In the electronic device 100 according to the exemplary embodiment of the present disclosure, the panel device 120 may be seen refracted when viewed from the front of the external protective layer 110 toward the panel device 120 since the center portion of the external protective layer 110 is thicker than the edge portion of the external protective layer 110. For instance, as shown in FIG. 2, the light irradiated in an edge direction from the center may be refracted by the external protective layer 110 to be irradiated in the front of the external protective layer 110. Accordingly, a black matrix area located at the edge of the panel device 120 may appear relatively small, and the center of the panel device 120 may appear to be enlarged, thereby improving a visibility of the electronic device 100. In addition, the electronic device 100 may have a stronger structure against impacts applied thereto from the outside since the edge of the external protective layer 110 has the circular shape.

Additionally, the electronic device 100 may further include a frame or a bezel surrounding the edge of the external protective layer 110. As another example, the electronic device 100 may further include a stem-winder disposed around the external protective layer 110, provided rotatably, and operated as an input member depending on a design scheme. According to various embodiments, at least a portion of the border of the external protective layer 110 may have a flat shape. As another example, the edge of the external protective layer 110 may have a quadrangular shape, and the center portion of the external protective layer 110 may have a convex shape.

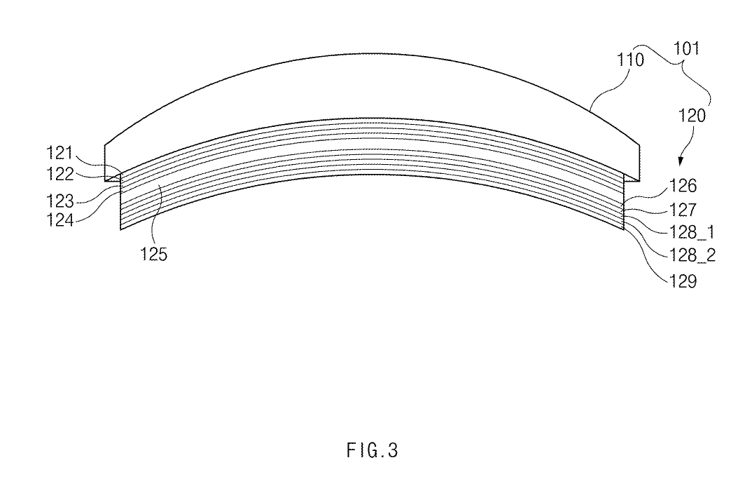

FIG. 3 is a view showing an example of a structure of the display according to an exemplary embodiment of the present disclosure.

Referring to FIG. 3, the display 101 may include the external protective layer 110, a first adhesive layer 121, a touch screen panel 122, a second adhesive layer 123, a polarization layer 124, a panel layer 125, a third adhesive layer 126, a lower film 127. In the exemplary embodiment, the touch screen panel 122 of the display 101 may be integrally provided with the polarization layer or the panel layer 125. Additionally, the structure of the display may include an embossed layer 128_1, a sponge 128_2, and a heat discharge layer 129, which are disposed under the display 101. The first adhesive layer 121, the touch screen panel 122, the second adhesive layer 123, the polarization layer 124, and the panel layer 125 may be, for example, included in the above-mentioned panel device 120. As another way, the panel device 120 may include the first adhesive layer 121, the touch screen panel 122, the second adhesive layer 123, the polarization layer 124, the panel layer 125, the third adhesive layer 126, and the lower film 127. As another example, the embossed layer 128_1 and the sponge 128_2 may be omitted in accordance with changes in the design scheme. According to an embodiment, the embossed layer 128_1 and the sponge 128_2, which are disposed under the panel device 120, may be omitted when the sensor (e.g., the illumination sensor or the image sensor) is disposed under the panel device 120.

As described above, the external protective layer 110 may have the shape (e.g., a convex shape) in which the center portion is more protruded upward than the edge portion. According to an embodiment, the external protective layer 110 may have the shape in which the upper portion surface and the lower portion surface are convex upward. The first adhesive layer 121 may adhere the touch screen panel 122 to the lower portion of the external protective layer 110. In this case, at least a portion of the first adhesive layer 121 may include an optical clear adhesive (OCA) by taking into account the visibility. The first adhesive layer 121 may be provided in the form of an adhesive film. The touch screen panel 122 may be adhered to the lower portion surface of the external protective layer 110 by the first adhesive layer 121. When the lower portion surface of the external protective layer 110 is convexly protruded upward, at least a portion of the touch screen panel 122 may be disposed to be partially convex while being adhered to the lower portion surface of the external protective layer 110. The touch screen panel 122 may sense an electrical variation with respect to an object approaching or making contact with the upper portion surface of the external protective layer 110 and may apply the sensed signal to the printed circuit board 150.

The second adhesive layer 123 may be disposed under the touch screen panel 122 to adhere the polarization layer 124 to the touch screen panel 122. The second adhesive layer 123 may include substantially the same material (e.g., the OCA) as the first adhesive layer 121. The polarization layer 124 may change a direction of the light irradiated to the external protective layer 110 from the panel layer 125. For instance, the polarization layer 124 may polarize the light such that the light irradiated from the panel layer 125 is uniformly transmitted to the external protective layer 110. According to various embodiments, the polarization layer 124 may include a plurality of polarization sheets having different polarization characteristics from each other and being stacked one on another. As another way, the polarization layer 124 may be omitted from the structure of the display. The polarization layer 124 may be placed on the panel layer 125.

The panel layer 125 may output a specified image in response to a signal provided from the printed circuit board 150 (e.g., a processor). For instance, the panel layer 125 may include at least one thin film transistor and a pixel electrode and may output the specified image in response to the power provided from the power device 130 and a processor control of the printed circuit board 150. At least one surface of the upper and lower portion surfaces of the panel layer 125 may be provided in a substrate with a flexible material (e.g., a flexible glass, plastic, or acryl), and the thin film transistor and the pixel electrode may be disposed between the upper and lower portion surfaces. The polarization layer 124 may be disposed on the panel layer 125. The panel layer 125 may include, for example, a liquid crystal display panel or an OLED panel. The panel layer 125 may be a flexible panel disposed under the external protective layer 110 and having a center portion convexly curved upward.

The third adhesive layer 126 may be disposed under the panel layer 125 to adhere the panel layer 125 to the lower film 127. The third adhesive layer 126 may include the same material as the first adhesive layer 121 or the second adhesive layer 123.

The lower film 127 may be disposed under the panel layer 125 and may serve as a reflective plate to improve a light irradiation effect of the panel layer 125. In this regard, one surface of the lower film 127, which faces the panel layer 125, may be formed of a material that easily reflects the light or may be polished. As another way, the lower film 127 may be coated with a metal material (e.g., an aluminum coating) such that a light reflectance is improved (e.g., such that the light reflectance is equal to or greater than a predetermined reference value) or may be formed of a material capable of reflecting the light above the predetermined reference value.

The embossed layer 128_1 may be disposed under the lower film 127 to support the display 101. The embossed layer 128_1 may support the display 101 such that the display 101 securely makes contact with the lower portion surface of the external protective layer 110. The sponge 128_2 may be disposed to support the embossed layer 128_1 and to allow the embossed layer 128_1 to exert an elasticity while the embossed layer 128_1 supports the display 101. The heat discharge layer 129 may discharge a heat generated during the drive of the display 101. The heat discharge layer 129, at least a portion of which is formed of a metallic material (e.g., copper), may ground the display 101 or the printed circuit board 150.

As described above, the center portion of the structure of the display 101 according to the exemplary embodiment of the present disclosure may be more convexly formed than the edge of the structure of the display 101 as a whole, and thus the edge may appear relatively narrow. Accordingly, the black matrix area disposed at the edge may appear relatively short in a certain direction to observe the electronic device 100. In addition, the cavity may be defined under the center portion of the display 101 according to the exemplary embodiment of the present disclosure. Various structures (e.g., the battery and the sensor device) of the electronic device 100 may be disposed in the cavity defined under the display 101. A space additionally secured under the display may be used to improve functions of the electronic device 100 (e.g., improvement of battery capacity, enlargement of speaker backhaul area of audio device).

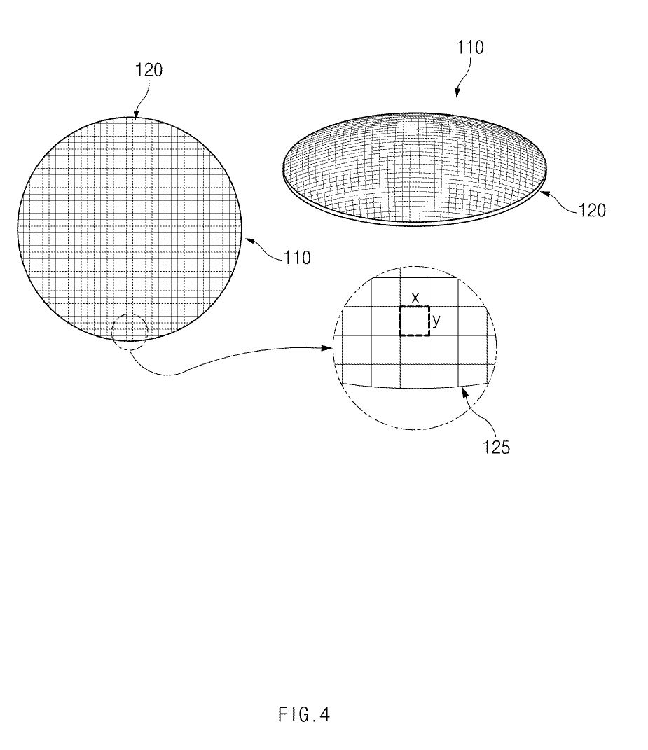

FIG. 4 is a view showing an example of a display according to an exemplary embodiment of the present disclosure.

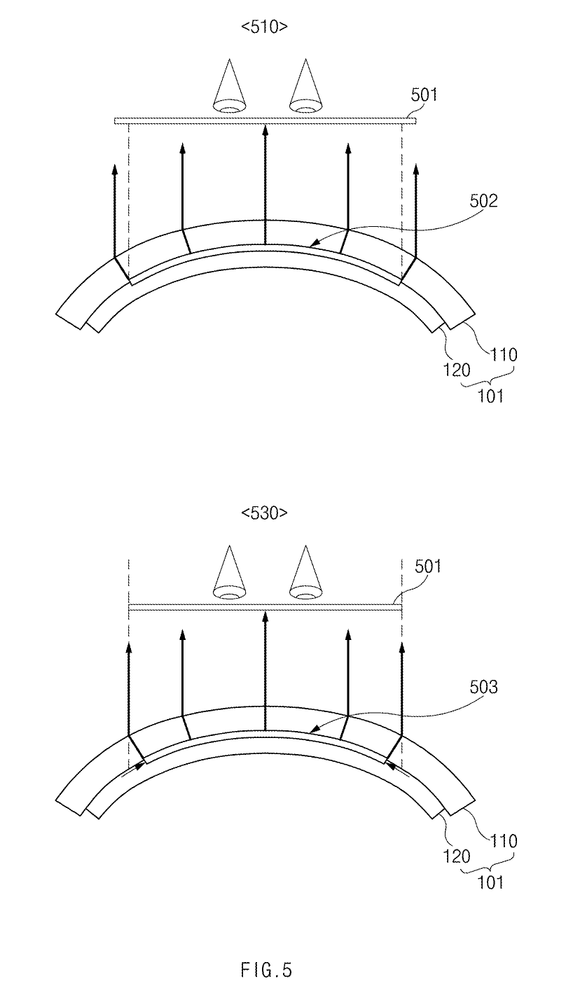

Referring to FIG. 4, the center portion of the external protective layer 110 of the display 101 of the present disclosure may be more protruded than the edge of the external protective layer 110. The panel layer 125 of the panel device 120 before being adhered to the external protective layer 110 may have a uniform pixel size. Accordingly, when the panel device 120 is disposed (e.g., lamination) under the external protective layer 110 in which the upper portion surface and the lower portion surface are convexly formed upward, the pixel size of the edge portion and the pixel size of the center portion of the panel layer 125 may be observed differently as shown in FIG. 4. For instance, the pixel observed in the edge portion of the external protective layer 110 may be observed as being distorted and expanded while being observed when compared with an actual pixel disposed in the panel layer 125. In addition, the pixel observed in the edge portion of the external protective layer 110 may be observed as being distorted and expanded or being distorted and contracted while being observed when compared with the actual pixel disposed in the panel layer 125 according to the thickness and shape of the external protective layer 110. For example, at least one of a length of an x-axis and a length of a y-axis of the pixel may be observed as being warped. Accordingly, the processor of the electronic device 100 may perform a coordinate correction described with reference to FIG. 5 in order to correct the distortion phenomenon.

FIG. 5 is a view showing an example of a distortion correction of a display according to an exemplary embodiment of the present disclosure.

Referring to FIG. 5, as described above, when the panel device 120 is disposed under the external protective layer 110 in which the upper and lower portion surfaces of the center portion are more convexly protruded upward than the edge, there is a difference between an observation image 501 displayed on the panel layer and an actual image 502 as shown in a state 510. For instance, the observation image 501 may be shown larger than the actual image 502. The image distortion may occur due to the angle of the curved surface and the thickness of the external protective layer 110 and a difference in refractive index between an air and the external protective layer 110. In a case of the convex (or dome) shape shown in FIG. 5, the image distortion may occur along the curved shape of the surface or in all direction with respect to a diameter of a circle.

Accordingly, the processor disposed in the printed circuit board 150 may correct a coordinate of the image displayed on the panel layer and may control to output a coordinate corrected image 503 to the panel layer as shown in a state 530. As shown in figures, regarding to the coordinate correction of the image, the processor of the electronic device 100 may correct the coordinate of the image such that the coordinate of the images displayed in the edge of the panel layer is shifted to the direction of the center portion. In the exemplary embodiment, the processor may not perform the coordinate correction of the images on the specific area of the center portion of the panel layer and may perform the coordinate correction of the images only on the specific area of the edge portion of the panel layer. As another way, the processor may apply a gradual increase in degree of the coordinate correction from the center portion to the edge portion of the panel layer (e.g., such that the coordinate is shifted to the direction of the center portion).

According to various embodiments, since excessive current consumption may occur when a correction algorithm (e.g., the coordinate correction of the image described above) is constantly applied, the processor of the electronic device 100 may selectively apply the correction algorithm depending on situations. For example, when simple information below a certain reference value (e.g., a case in which the number of objects displayed is equal to or smaller than a certain number or the size of the object with colors is equal to or smaller than a certain size, for example, a case in which only objects corresponding to clock numbers are displayed, a case in which only monochrome screen is displayed) is displayed on the panel device 120, the processor may control not to apply the correction algorithm. As another way, the processor may apply the correction algorithm when the type of the displayed object or a specified reference value about the object is high (e.g., when a portrait is displayed). According to various embodiments, the processor of the electronic device 100 may selectively apply the correction algorithm depending on the type of application presently displayed (or executed).

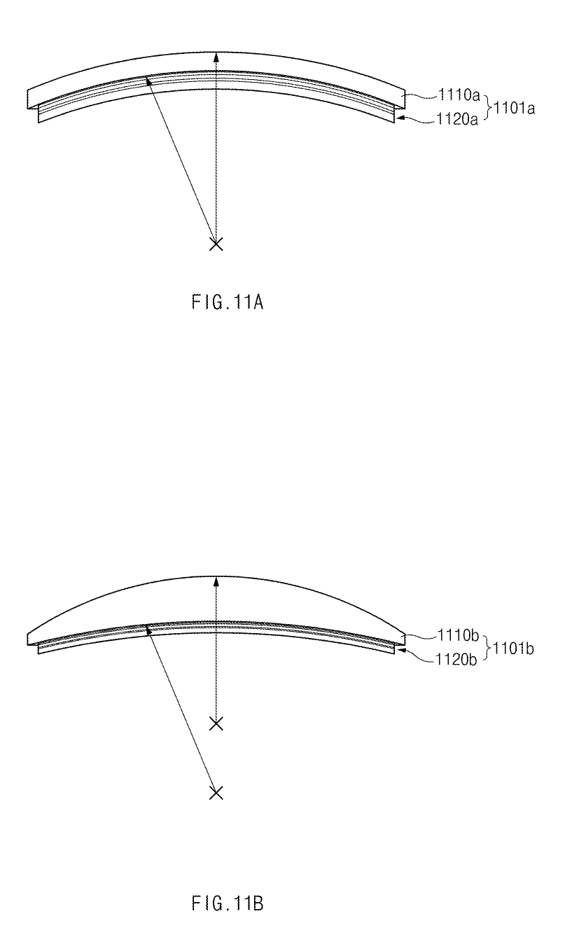

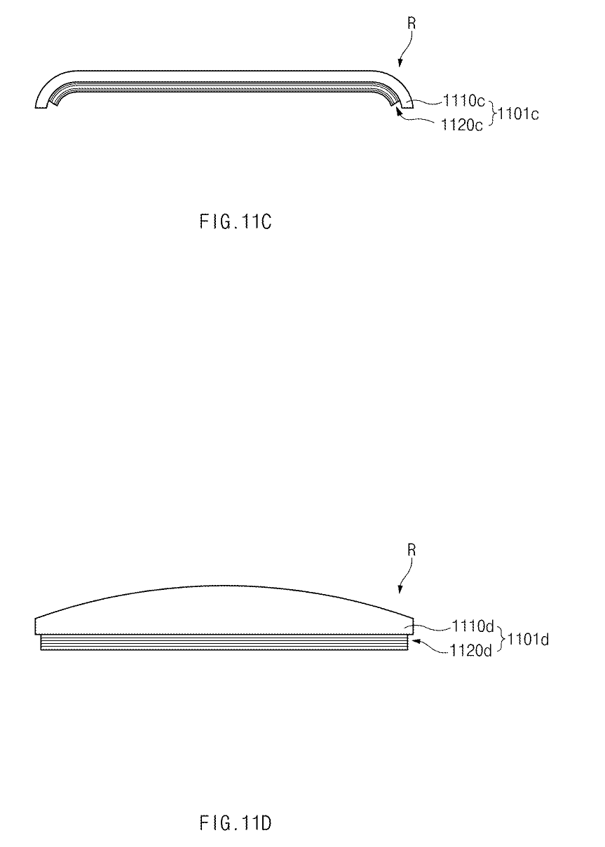

The display to which the above-mentioned correction algorithm is applied may be applied to displays with various shapes described with reference to FIGS. 11A to 11D. For instance, when the panel device is flat and at least the portion of the external protective layer has the curvature, the correction algorithm may be applied in a similar way to when the panel device has the certain curvature. When the panel device is flat and at least the portion of the external protective layer has the curvature, the coordinate correction may be performed on the image with respect to the difference in refractive index between the external protective layer and the air layer. Regarding to the above-mentioned coordinate correction, the electronic device 100 may store an applied value with respect to an area on which the coordinate correction is performed in the memory and may perform the coordinate correction on the image based on the applied value. According to various embodiments, the processor of the electronic device may determine a user's gaze, a current placement of the electronic device, or a direction to which the display faces based on the mounted sensor. The processor of the electronic device may adjust an amount and a size of information to be output to the display (e.g., displays the object through only some areas of the display or adjust a size of the object to be output (e.g., to be relatively small or large)) based on the determined result. In addition, the processor may control a position in the display through which the object is displayed (e.g., disposing an object with a certain size at a center of screen). As described above, the electronic device 100 may partially output the object through the display according to the thickness of the external protective layer with respect to areas that may not be visible in the user's specific line of sight.

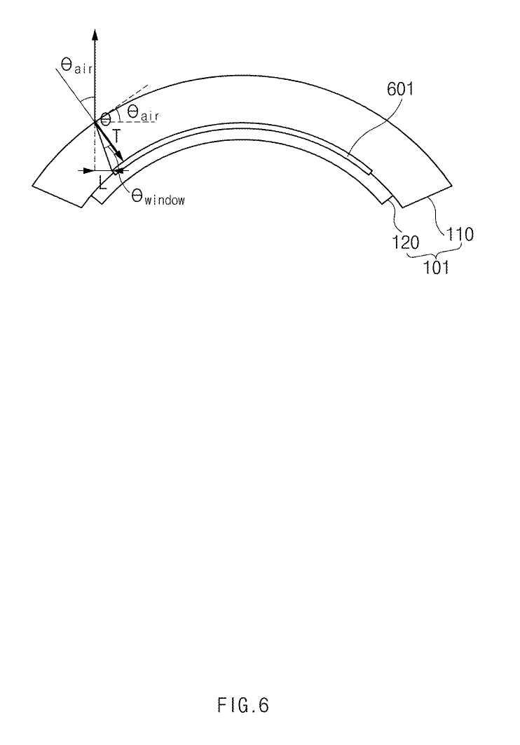

FIG. 6 is a view showing an example of a distortion correction calculation of a display according to an exemplary embodiment of the present disclosure.

Referring to FIG. 6, when the display 101 includes the convex external protective layer 110 and the panel device 120 is disposed under the convex external protective layer 110 to be convex, the processor of the electronic device 100 may determine the amount of the coordinate correction of the image based on the following Equation 1 and Equation 2 and may output an image 601 whose coordinate is corrected based on the determined amount of the coordinate correction.

$$\begin{matrix}\frac{sin {θ}_{Air}}{sin {θ}_{window}} = \frac{{n}_{window}}{{n}_{Air}} & Equation 1 \\ β = {sin}^{- 1} ( \frac{{n}_{window}}{{n}_{Air}} sin α ) & Equation 2\end{matrix}$$

Equation 1 indicates a relation between an incident angle and an existing angle of a light depending on a relative refractive index. In Equation 1, “nAir” denotes a refractive index of air and may be “1”. “nwindow” denotes a refractive index according to a material of the external protective layer 110 and may vary depending on the material of the external protective layer 110 employed in the electronic device 100. The “a” may become “Mir”, and the “β” may become “θwindow”. The thickness “T” of the external protective layer 110 may be determined by measured values for each position of the external protective layer 110. When the thickness “T” and the “β” value of the external protective layer 110 are calculated, a length of a hypotenuse of “β” may be calculated based on a trigonometric equation (e.g., a cosine function). When the length of the hypotenuse is calculated, an “L” value indicating a distorted distance may be calculated based on the trigonometric equation. For instance, the distorted distance “L” may be calculated by using the trigonometric equation (e.g., a sine function) based on an angle “α-β” and the length of the hypotenuse previously calculated, which are related to the distorted distance “L”.

When the distorted distance “L” is calculated through the above-mentioned method, the processor mounted on the printed circuit board 150 may adjust the shape of the image, which is to be output to the panel layer, depending on a size of the distorted distance “L”, and then may output the adjusted image 601. For example, the processor may allocate relatively fewer pixels to the image output to an area of the panel layer, which appears distorted relatively longer. For example, when four pixels are required to display a red color for presenting a specified image, the processor may process two pixels to display the red color. As another way, the processor may allocate relatively more pixels to the image output to an area of the panel layer, which appears distorted relatively narrower. For example, when two pixels are required to display a blue color for presenting a specified image, the processor may process three pixels to display the blue color.

According to various embodiments, the thickness of the center portion of the external protective layer 110 may be different from the thickness of the edge portion of the external protective layer 110. In this case, the thickness “T” of the external protective layer 110 may be stored in the memory after being measured in advance, and the distorted distance “L” applied to each position of the panel layer may be calculated. The processor may store and manage a table associated with distorted distances “L” for the entire of the panel layer and may perform the image distortion correction based on the table.

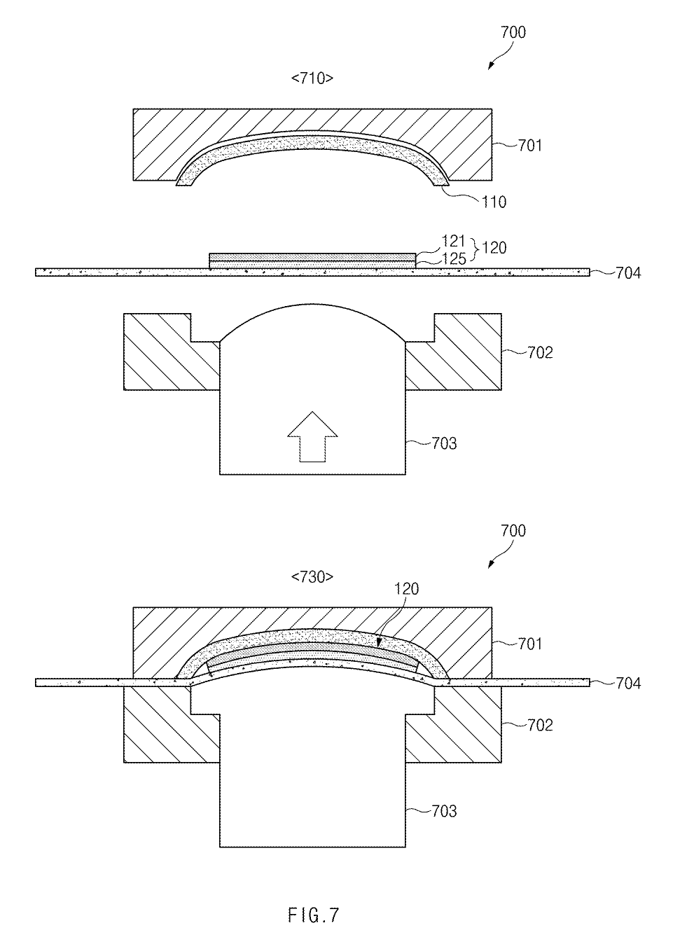

FIG. 7 is a view showing an example of a manufacturing process of a display according to an exemplary embodiment of the present disclosure.

Referring to FIG. 7, in association with the manufacturing process of the display of the present disclosure, a display manufacturing apparatus 700 may include an upper jig 701, a lower jig 702, a pressing jig 703, the external protective layer 110 having the convex shape, the panel device 120 having the flat shape (e.g., the panel layer 125 and the adhesive layer 121), and a guide film 704 as shown in a state 710. Additionally, the display manufacturing apparatus 700 may further include a fixing device for fixing the guide film 704 and a moving member for moving the lower jig 702 and the pressing jig 703 in a stepwise manner. In addition, as described above, the panel device 120 may further include other adhesive layers, the touch screen panel, the polarization layer, and the lower film in addition to the adhesive layer 121 and the panel device 125.

The external protective layer 110 may have the shape with the specified curvature and thickness (e.g., same thickness or partially different thicknesses). The external protective layer 110 may be fixed to an inner side surface of the upper jig 701. The upper jig 701 may be formed of a material (e.g., a rubber or silicon) having a specified strength and elasticity such that the external protective layer 110 is not damaged by a force acting upward from a bottom of the external protective layer 110. The upper jig 701 may have an internal cavity that is the same as or similar to the shape of the upper portion surface of the external protective layer 110 such that the external protective layer 110 may be inserted and fixed. In addition, the upper jig 701 may have a structure that enables the external protective layer 110 to be fixed. For instance, the upper jig 701 may include at least one air suction hole or sucker defined in an inner wall thereof making contact with the external protective layer 110.

The guide film 704 may be disposed between the upper jig 701 and the lower jig 702 to support the panel layer 125 with the adhesive layer 121 coated thereon. The guide film 704 may align the panel layer 125 such that the panel layer 125 is inserted while being aligned inside the external protective layer 110. The guide film 704 may be formed of a flexible material. Accordingly, when the lower jig 702 and the pressing jig 703 move upward from the bottom of the guide film 704, a portion of the guide film 704, to which a force is applied, may be curved. According to an embodiment, the guide film 704 may be fixed flat at an edge portion at which the upper jig 701 meets the lower jig 702, and a center portion of the guide film 704, in which the pressing jig 703 moves upward, may gradually extend to support the panel layer 125 while the panel layer 125 with the adhesive layer 121 coated thereon moves to the bottom of the external protective layer 110.

In the lower jig 702, a portion on which the panel layer 125 is placed may be engraved, and the other portion may be flat. A hole may be defined inside the engraved area of the lower jig 702. The pressing jig 703 may be disposed in the hole defined in the lower jig 702 and may move to have a different moving distance from the lower jig 702. For instance, the upward movement of the lower jig 702 may be stopped while the lower jig 702 makes contact with the upper jig 701 with the guide film 704 disposed therebetween. Then, as the pressing jig 703 moves upward, the guide film 704 may be pushed upward by the pressing jig 703. The pressing jig 703 may be formed of a material such as silicon or rubber whose outer shape is deformed in a certain shape due to a pressure applied thereto. Accordingly, when the upper jig 701 and the lower jig 702 are engaged with each other in the form of a chamber, the pressing jig 703 may be expanded to the engraved area of the pressing jig 703 due to the pressure applied to the pressing jig 703 as shown in a state 730, to thereby press the guide film 704 upward. Accordingly, the panel layer 125 disposed on the guide film 704 may uniformly make contact with the curved lower portion surface of the external protective layer 110. The adhesive layer 121 disposed on the panel layer 125 may securely maintain the state in which the external protective layer 110 and the panel layer 125 are attached to each other.

When the lower jig 702 is separated from the upper jig 701 after the pressing is completed, the pressing jig 703 may return to its original state as shown in the state 710. The guide film 704 may be removed after the panel layer 125 makes contact with the lower portion of the external protective layer 110 by the adhesive layer 121.

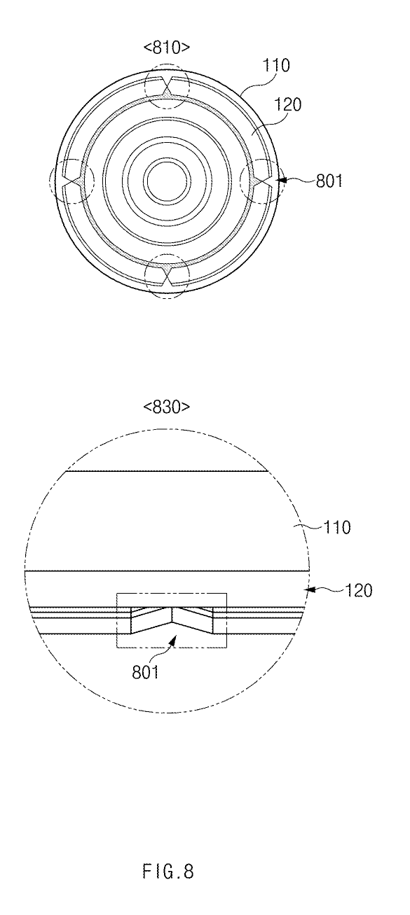

FIG. 8 is a view showing an example of a crease prevention structure of a display according to an exemplary embodiment of the present disclosure.

Referring to FIG. 8, the panel device 120 of the display 101 according to the present disclosure may include a cut-away area 801 obtained by cutting away at least a portion of an edge of the panel device 120 or at least one (e.g., at least one of the adhesive layer, the panel layer, the touch screen, the polarization layer, the lower film, the embossed layer, the sponge, or the heat discharge layer) of a plurality of layers for the panel device 120 as shown in a state 810. The cut-away area 801 may be cut in a triangular shape or an arc shape as shown in a state 830. The cut-away area 801 may have a depth included in a range of the black matrix area (or thickness). In FIG. 8, the panel device 120 having the cut-away area 801 is disposed under the external protective layer 110, however, the black matrix may be disposed at the border of the external protective layer 110 such that at least a portion of the cut-away area 801 of the panel device 120 is not observed from the outside. FIG. 8 shows four cut-away areas 801, but the number of the cut-away areas 801 should not be limited to four. For instance, the number and size of the cut-away areas 801 may vary depending on a bending modulus of the external protective layer 110 and a size of the external protective layer 110. For example, when the bending modulus of the external protective layer 110 is large (e.g., a degree of convexity is relatively severe), the number or size of the cut-away areas 801 may increase. As the size of the external protective layer 110 increases, the number or size of the cut-away areas 801 may increase. On the contrary, when the bending modulus of the external protective layer 110 is small (e.g., the degree of convexity is relatively small) or as the size of the external protective layer 110 decreases, the number or size of the cut-away areas 801 may decrease. The shape of the cut-away area 801 may also be adjusted. For instance, the cut-away area 801 may have a polygonal shape such as a lozenge. As another way, the cut-away area 801 may have a semi-circular shape or a semi-oval shape to prevent a vertex portion of the cut-away portion from being damaged due to a force concentrated at the vertex portion.

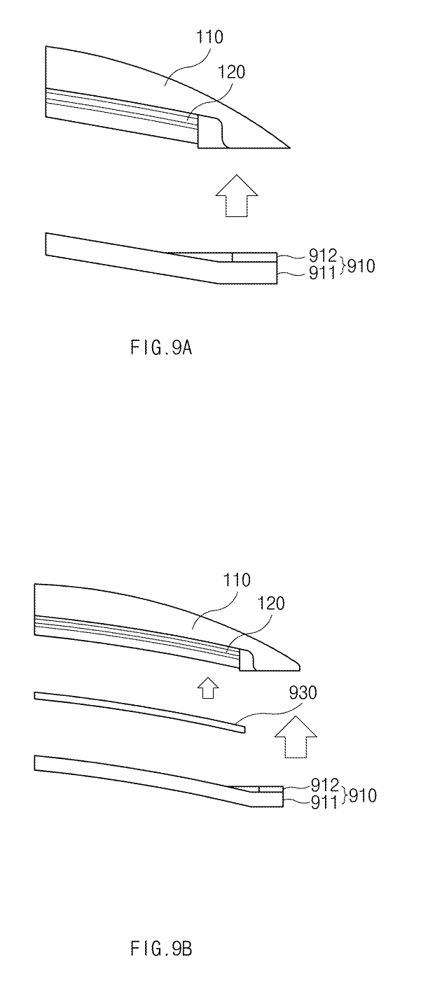

FIGS. 9A and 9B are views showing other examples of a crease prevention structure of a display according to an exemplary embodiment of the present disclosure.

Referring to FIG. 9A, the crease prevention structure of the display according to the exemplary embodiment of the present disclosure may further include, for example, a lower supporter 910 that supports the panel device 120 disposed under the external protective layer 110. The lower supporter 910 may include a support body 911 and a support adhesive layer 912. The support body 911 may have, for example, the same or similar shape as the curved shape of the panel device 120. As another example, the support body 911 may have a shape in which a center portion is protruded upward and an edge portion is formed flat with a constant thickness. A center lower portion of the support body 911 may have a convex shape upward. The support adhesive layer 912 may be disposed at the edge portion with a band shape of the support body 911. Accordingly, when the support body 911 is disposed under the panel device 120, at least a portion of the support body 911 may be disposed to push the panel device 120 upward to the external protective layer 110 and to press the edge portion of the panel device 120. Thus, the crease phenomenon may be prevented from occurring in the edge portion of the panel device 120 or the panel layer 125.

The support adhesive layer 912 may be disposed at an edge of the support body 911 and adhered to the edge of the external protective layer 110. Since the support adhesive layer 912 fixes the support body 911 to the external protective layer 110, the support body 911 may be disposed to press the panel device 120 to the external protective layer 110. The support adhesive layer 912 may be, for example, a double-sided adhesive tape. As the edge portion of the support body 911 has the band shape, the support adhesive layer 912 may have a band shape.

Referring to FIG. 9B, the crease prevention structure of the display according to the exemplary embodiment of the present disclosure may further include, for example, a lower supporter 910 that supports the panel device 120 disposed under the external protective layer 110 and an auxiliary layer 930 (e.g., a silicon layer) disposed between the panel device 120 and the lower supporter 910. A rigid degree (or hardness) of the auxiliary layer 930 may be weaker (or softer, or relatively smaller hardness) than that of the panel device 120 or the lower supporter 910. The auxiliary layer 930 may have a shape (e.g., an upwardly convex shape) corresponding to the shape of the lower portion of the panel device 120. In addition, a cavity may be defined under a center portion of the auxiliary layer 930. An upper portion surface of the auxiliary layer 930 may make contact with the lower portion surface of the panel device 120. A lower portion surface of the auxiliary layer 930 may make contact with the upper portion surface of the lower supporter 910. Accordingly, when the lower supporter 910 makes contact with the external protective layer 110, the support body 911 may adhere the panel device 120 to the lower portion of the external protective layer 110 with the auxiliary layer 930. In this case, since the auxiliary layer 930 makes contact with the lower portion of the panel device 120 while being pressed, the lower supporter 110 may uniformly adhere the entire of the lower portion surface of the panel device 120 to the lower portion surface of the external protective layer 110. As described above, the structure shown in FIG. 9B may evenly and tightly transmit the force caused by the lower supporter 910 to the panel device 120 through the auxiliary layer 930, and thus the crease of the panel device 120 may be reliably prevented from occurring.

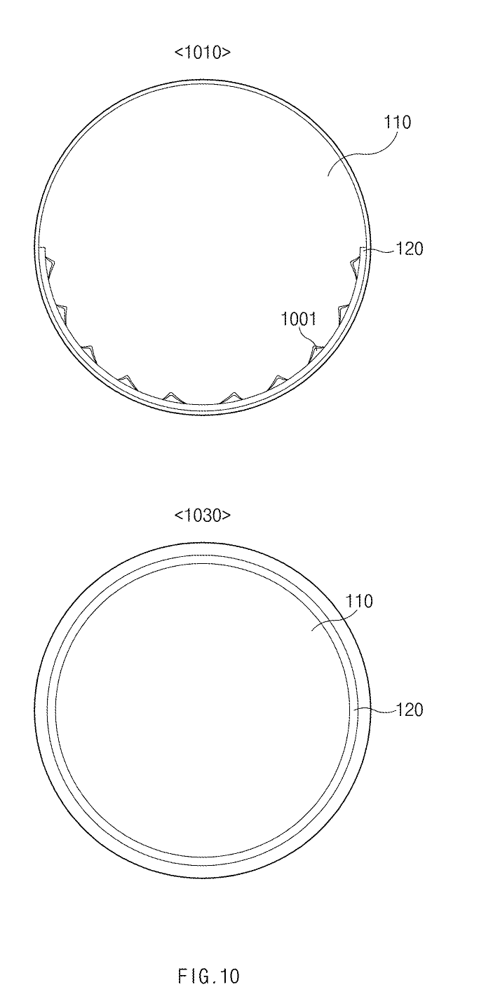

FIG. 10 is a view explaining a process on crease in a structure of a display according to an exemplary embodiment of the present disclosure.

Referring to FIG. 10, when the lower portion surface of the external protective layer 110 has the convex shape as shown in a state 1010, a crease 1001 may be formed at the border of the panel device 120 disposed along the convex shape of the lower portion surface of the external protective layer 110. The crease may be formed by adhering the panel device 120 having the flat shape to the curved lower portion surface of the external protective layer 110. However, the display employing the structure described with reference to FIG. 8A or the structure described with reference to FIGS. 9A and 9B may have the constant edge shape as shown in a state 1030 without generating the crease 1001.

FIGS. 11A to 11D are views showing various shapes of a display according to an exemplary embodiment of the present disclosure.

Referring to FIG. 11A, a first display 1101a may include a first external protective layer 1110a having a constant thickness and a first panel device 1120a.

The first external protective layer 1110a may have, for example, a shape in which a center portion is located at a higher position than a peripheral portion. For instance, an upper portion surface of the first external protective layer 1110a may have a shape in which a height of the upper portion surface gradually decreases from the center portion to an edge with respect to a bottom surface. In the same or similar way, a lower portion surface of the first external protective layer 1110a may have a shape in which a height of the lower portion surface gradually decreases from the center portion to the edge with respect to the bottom surface. A curvature of the upper portion surface of the first external protective layer 1110a may be the same as or similar to a curvature of the lower portion surface of the first external protective layer 1110a. Accordingly, a center point of an upper curved surface of the first external protective layer 1110a may be the same as a center point of a lower curved surface of the first external protective layer 1110a.

The first panel device 1120a may include at least one adhesive layer, a touch screen, and a panel layer as described above. Additionally, the first panel device 1120a may further include a lower supporter to prevent a crease phenomenon from occurring in the panel layer. The adhesive layer may adhere the touch screen to the polarization layer and the panel layer and may adhere the first panel device 1120a to the lower portion of the first external protective layer 1110a. Each component (e.g., at least one of the touch screen, the polarization layer, the panel layer, the lower film, or the lower supporter) of the first panel device 1120a may be curved in the same or similar way as the lower portion surface of the first external protective layer 1110a.

Referring to FIG. 11B, a second display 1101b may include a second external protective layer 1110b, in which a thickness of a center portion thereof is different from a thickness of an edge thereof, and a second panel device 1120b.

The second external protective layer 1110b may be formed such that the thickness of the center portion is thicker than the thickness of the edge. Accordingly, a center point of an upper curved surface of the second external protective layer 1110b may be formed different from a center point of a lower curved surface of the second external protective layer 1110b. For instance, the center point of the lower curved surface of the second external protective layer 1110b may be located at a lower position than the center point of an upper curved surface of the second external protective layer 1110b. In addition, the second external protective layer 1110b may have the shape whose thickness gradually decreases from the center portion to the edge. A bending modulus of the second external protective layer 1110b may increase (e.g., a curved degree increases or a slope becomes steep) as a distance from the center portion decreases, and the bending modulus of the second external protective layer 1110b may decrease (e.g., a curved degree decreases or a slope becomes gentle) as a distance from the edge decreases. Accordingly, an image displayed through the second panel device 1120b of the second display 1101b may have the bending modulus that varies depending on its position due to the second external protective layer 1110b and an air layer.

The second panel device 1120b may be disposed under the second external protective layer 1110b. In this case, the second panel device 1120b may make close contact with the lower curved surface of the second external protective layer 1110b. Accordingly, the second panel device 1120b may have the same or similar shape as the curved shape of the lower curved surface of the second external protective layer 1110b. An entire size of the second panel device 1120b may be smaller than an entire size of the lower curved surface of the second external protective layer 1110b, and thus the second panel device 1120b may be covered by the second external protective layer 1110b.

Referring to FIG. 11C, a third display 1101c may include a third external protective layer 1110c, in which at least a portion of a center portion thereof is flat and an edge portion thereof is curved, and a third panel device 1120c.

The third external protective layer 1110c may include, for example, a flat area provided in a flat shape from the center portion to a specified point of the edge portion by a specified distance and a curved area provided in a curved shape from the specified point of the edge portion to an edge of the third external protective layer 1110c. The flat area may be provided in a circular area when the third display 1101c has a partially spherical shape. The curved area may be provided in a band shape and disposed to surround the flat area. The black matrix may be disposed in the curved area of the electronic device 100. In this case, the black matrix may appear to be refracted due to the curved area, and thus the black matrix may appear smaller than actual size.

The third panel device 1120c may make close contact with a lower portion surface of the third external protective layer 1110c. Accordingly, the third panel device 1120c may include a flat area and a curved area similar to the third external protective layer 1110c. In the panel layer included in the third panel layer 1120c, a pixel of the panel layer may be observed to have the same pixel size as the actual pixel in the flat area and may be observed to have a larger (or smaller) pixel size than the actual pixel in the curved area when viewed from the outside.

Referring to FIG. 11D, a fourth display 1101d may include a fourth external protective layer 1110d, in which a center portion of an upper portion surface thereof is located at a higher position than an edge and a lower portion surface thereof is formed flat, and a fourth panel device 1120d.

As shown in FIG. 11D, the center portion of the upper portion surface of the fourth external protective layer 1110d may be located at the higher position than an edge portion of the upper portion surface. In addition, the fourth external protective layer 1110d may be formed such that the height gradually decreases from the center portion of the upper portion surface to the edge. The lower portion surface of the fourth external protective layer 1110d may be formed flat. Accordingly, an entire shape of the fourth external protective layer 1110d may correspond to a vertical cross-sectional shape of a convex mirror.

The fourth panel device 1120d may be disposed under the fourth external protective layer 1110d. Since the lower portion of the fourth external protective layer 1110d is formed flat, the fourth panel device 1120d may be formed flat. An entire size of the fourth panel device 1120d may be smaller than an entire size of the lower portion surface of the fourth external protective layer 1110d. In the above-mentioned structure, an image displayed through the fourth panel device 1120d may appear to be convexly curved due to a difference in thickness of the fourth external protective layer 1110d.

When one of the first to fourth external protective layers 1110a to 1110d is applied, the processor mounted on the printed circuit board 150 may apply the coordinate correction to the curved area and output the corrected coordinate to the panel layer. The distorted distance associated with the coordinate correction may be calculated by the method described with reference to FIG. 6.

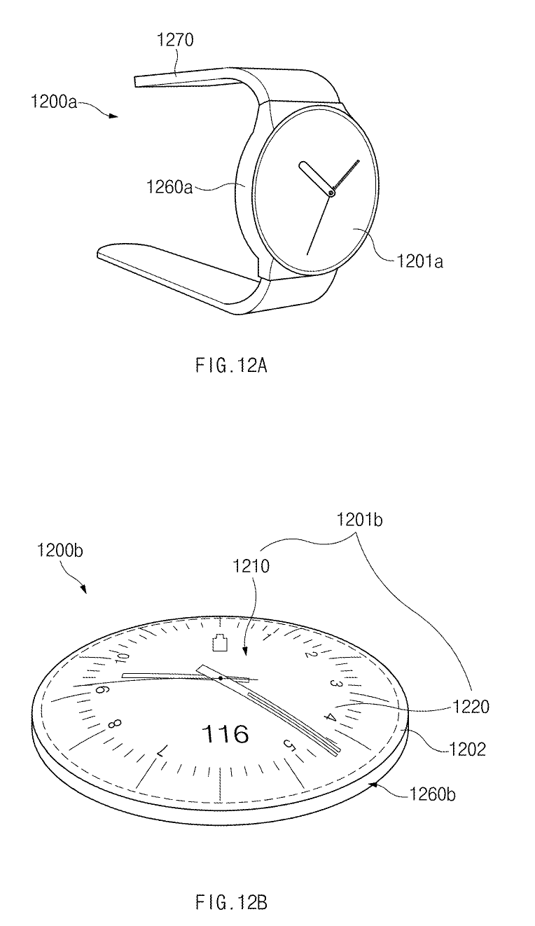

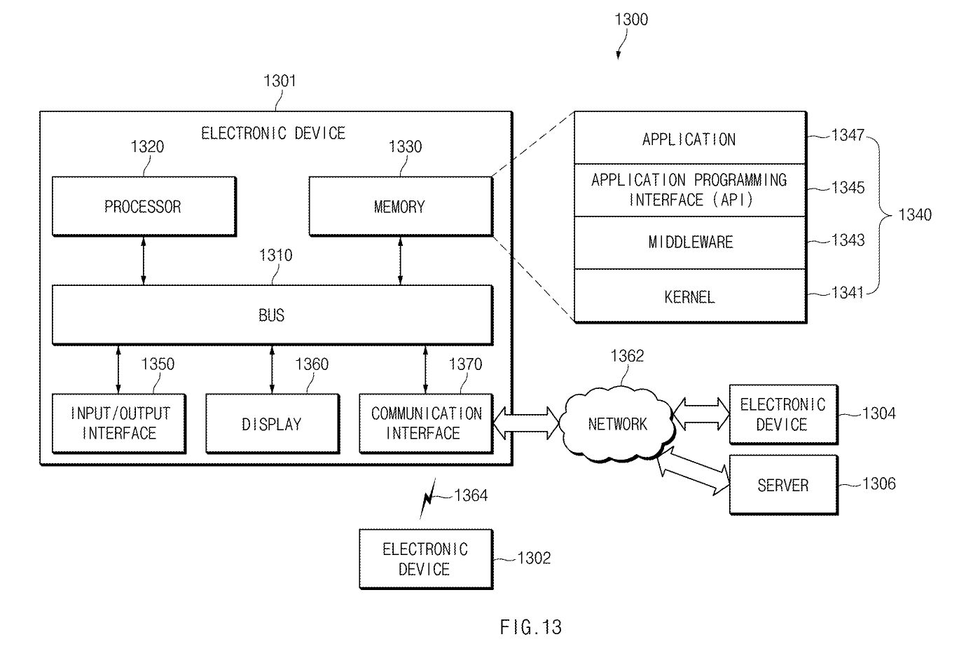

FIGS. 12A and 12B are views showing examples of an exterior of an electronic device to which a display is applied according to an exemplary embodiment of the present disclosure.

Referring to FIG. 12A, a first display 1201a of the present disclosure may be applied to a wearable electronic device 1200a. The first display 1201a shown in FIG. 12A may employ one of the structures described with reference to FIGS. 11A to 11D. The processor included in the wearable electronic device 1200a may apply the coordinate correction on the image in the curved area or the area in which the pixels appear to be relatively distorted when compared with other areas. As described above, the coordinate correction may include an operation for adjusting a distorted degree according to at least one of the curved degree of the external protective layer or the thickness of the external protective layer at the position of the image actually displayed on the display. The wearable electronic device 1200a may further include a case 1260a surrounding the first display 1201a and a fixing device 1270 (e.g., a strap) connected to the case 1260a to fix the electronic device to a certain part of the wearer. When the wearable electronic device 1200a is worn on a user's neck, the fixing device 1270 may be replaced by a string.

Referring to FIG. 12B, a second display 1201b of the present disclosure includes a flexible panel device whose edge has a circular or polygonal shape and the second display 1201b is applied to an electronic device 1200b having a spherical shape in which at least a portion of a center portion is located at a higher position than a peripheral portion. As shown in FIG. 12B, a case 1260b may be disposed to expose an entire upper portion surface of the second display 1201b to the outside and to surround at least a portion of a side portion of the second display 1201b. The second display 1201b may include an external protective layer 1210 and a panel device 1220. A black matrix 1202 may be disposed between a lower portion of a border area of the external protective layer 1210 and the panel device 1220. As shown in FIG. 12B, in the second display 1201b having the shape in which the center portion is protruded, the black matrix 1201 may be perceived as relatively smaller due to a refracted view of an edge portion. The first display 1201a or the second display 1201b shown in FIG. 12A or 12B may display the image, on which the coordinate correction is performed, depending on the application of the convex external protective layer through the panel layer.

According to various embodiments, the electronic device according to an embodiment may include the panel device outputting the specified image using the power applied thereto, the external protective layer having a specified transparency and disposed on the panel device to protect the panel device, and a case disposed under the external protective layer and receiving the panel device mounted thereon, the external protective layer may be provided such that the thickness of the center portion of the upper portion surface is greater than the thickness of the peripheral portion, and the panel device may include the panel layer outputting the specified image in response to the power applied thereto and an adhesive layer adhering the panel layer to the lower portion of the external protective layer.

According to various embodiments, the black matrix may have the constant thickness and may be disposed between the lower portion of the edge of the external protective layer and the panel device.

According to various embodiments, the external protective layer may have the convex shape in which the center portion of the lower portion surface is more protruded than the peripheral portion.

According to various embodiments, the external protective layer may have the constant thickness.

According to various embodiment, the specific portion of the center portion of the external protective layer may be formed flat, and the specific portion of the edge portion of the external protective layer may be formed to have the specified curvature.

According to various embodiments, the lower portion surface of the external protective layer may be formed flat.

According to various embodiments, the external protective layer may have the shape whose thickness gradually decreases from the center to the edge.

According to various embodiments, the panel device may be disposed to be convex along the lower portion surface of the external protective layer.

According to various embodiments, the electronic device may further include the power device to supply the power.

According to various embodiments, the power device may include a battery (e.g., the coin shape) disposed inside the panel device having the convex shape.

According to various embodiments, the power device may include the batteries electrically connected to each other and having different diameters from each other.

According to various embodiments, the electronic device may further include the lower supporter supporting the panel device such that the panel device is adhered to the lower portion surface of the external protective layer.

According to various embodiments, the lower supporter may include the support adhesive layer adhered to the edge of the external protective layer and the support body making contact with the lower portion surface of the panel device and upwardly supporting the panel device such that the panel device is adhered to the external protective layer.

According to various embodiments, the electronic device may further include the auxiliary layer formed of the flexible material and disposed between the panel device and the lower supporter.

According to various embodiments, the panel device may include at least one cut-away portion formed by cutting the border of the panel device.

According to various embodiments, the electronic device may further include the printed circuit board disposed under the battery or the panel device and including the hardware mounted thereon and related to the control of the panel device and the processor mounted on the printed circuit board, and the processor may be configured to output the image displayed on the panel device after performing the coordinate correction on the image by taking into account the distorted degree due to the external protective layer. The electronic device may further include the memory that stores the table including the information about the thickness for each position of the external protective layer.

According to various embodiments, the electronic device may further include the sensor device that collects the sensor information related to the operation of the electronic device.

According to various embodiment, the display according to an embodiment may include the panel device outputting the specified image using the power applied thereto and the external protective layer having the specified transparency and disposed on the panel device to protect the panel device, the external protective layer may be provided such that the thickness of the center portion of the upper portion surface is greater than the thickness of the peripheral portion, and the panel device may include the panel layer outputting the specified image in response to the power applied thereto and an adhesive layer adhering the panel layer to the lower portion of the external protective layer.

According to various embodiments, the external protective layer may have the convex shape in which the center portion of the lower portion surface is more protruded than the peripheral portion, and the panel device may be disposed to be convex along the lower portion surface of the external protective layer.

FIG. 13 is a view showing an example of an operating environment of an electronic device according to an exemplary embodiment of the present disclosure.

Referring to FIG. 13, according to various embodiments, an electronic device 1301 in a network environment 1300 is described. The electronic device 1301 (e.g., the electronic device 100) may include a bus 1310, a processor 1320, a memory 1330, an input/output interface 1350, a display 1360, and a communication interface 1370. According to an embodiment, the electronic device 1301 may not include at least one of the above-described components or may further include other component(s). The bus 1310 may interconnect the above-described components 1320 to 1370 and may include a circuit for conveying communications (e.g., a control message or data) among the above-described components. The processor 1320 (e.g., the processor of the electronic device 100) may include one or more of a central processing unit (CPU), an application processor (AP), or a communication processor (CP). For example, the processor 1320 may perform an arithmetic operation or data processing associated with control and/or communication of at least other components of the electronic device 1301.

The memory 1330 may include a volatile and/or nonvolatile memory. For example, the memory 1330 may store commands or data associated with at least one other component(s) of the electronic device 1301. According to an embodiment, the memory 1330 may store software and/or a program 1340. The program 1340 may include, for example, a kernel 1341, a middleware 1343, an application programming interface (API) 1345, and/or an application program (or “an application”) 1347. At least a part of the kernel 1341, the middleware 1343, or the API 1345 may be referred to as an “operating system (OS)”. For example, the kernel 1341 may control or manage system resources (e.g., the bus 1310, the processor 1320, the memory 1330, and the like) that are used to execute operations or functions of other programs (e.g., the middleware 1343, the API 1345, and the application program 1347). Furthermore, the kernel 1341 may provide an interface that allows the middleware 1343, the API 1345, or the application program 1347 to access discrete components of the electronic device 1301 so as to control or manage system resources.

The middleware 1343 may perform, for example, a mediation role such that the API 1345 or the application program 1347 communicates with the kernel 1341 to exchange data. Furthermore, the middleware 1343 may process task requests received from the application program 1347 according to a priority. For example, the middleware 1343 may assign the priority, which makes it possible to use a system resource (e.g., the bus 1310, the processor 1320, the memory 1330, or the like) of the electronic device 1301, to at least one of the application program 1347 and may process the one or more task requests. The API 1345 may be, for example, an interface through which the application program 1347 controls a function provided by the kernel 1341 or the middleware 1343, and may include, for example, at least one interface or function (e.g., an instruction) for a file control, a window control, image processing, a character control, or the like. The input/output interface 1350 may transmit a command or data input from a user or another external device, to other component(s) of the electronic device 1301 or may output a command or data, received from other component(s) of the electronic device 1301, to a user or another external device.

The display 1360 may include, for example, a liquid crystal display (LCD), a light-emitting diode (LED) display, an organic LED (OLED) display, a microelectromechanical systems (MEMS) display, or an electronic paper display. The display 1360 may display, for example, various contents (e.g., a text, an image, a video, an icon, a symbol, and the like) to a user. The display 1360 may include a touch screen and may receive, for example, a touch, gesture, proximity, or hovering input using an electronic pen or a part of a user's body.

For example, the communication interface 1370 may establish communication between the electronic device 1301 and an external device (e.g., the first external electronic device 1302, the second external electronic device 1304, or the server 1306). For example, the communication interface 1370 may be connected to the network 1362 over wireless communication or wired communication to communicate with the external device (e.g., the second external electronic device 1304 or the server 1306).

The wireless communication may include cellular communication which uses at least one of, for example, long-term evolution (LTE), LTE Advanced (LTE-A), Code Division Multiple Access (CDMA), Wideband CDMA (WCDMA), Universal Mobile Telecommunications System (UMTS), Wireless Broadband (WiBro), Global System for Mobile Communications (GSM), or the like. According to an embodiment, the wireless communication may include at least one of wireless fidelity (WiFi), Bluetooth, Bluetooth low energy (BLE), Zigbee, near field communication (NFC), magnetic stripe transmission (MST), radio frequency (RF), a body area network (BAN), or the like. According to an embodiment, the wireless communication may include GNSS. The GNSS may include one of, for example, a global positioning system (GPS), a global navigation satellite system (Glonass), a Beidou navigation satellite system (hereinafter referred to as “Beidou”), or an European global satellite-based navigation system (hereinafter referred to as “Galileo”). Hereinafter, in the present disclosure, “GPS” and “GNSS” may be interchangeably used. The wired communication may include at least one of, for example, a universal serial bus (USB), a high definition multimedia interface (HDMI), a recommended standard-232 (RS-232), power-line communication, a plain old telephone service (POTS), or the like. The network 1362 may include at least one of telecommunications networks, for example, a computer network (e.g., LAN or WAN), an Internet, or a telephone network. The electronic device 1301 may communicate with the first electronic device 1302 based on short-range communication 1364.

Each of the first and second external electronic devices 1302 and 1304 may be a device of which the type is different from or the same as that of the electronic device 1301. According to various embodiments, all or a portion of operations that the electronic device 1301 will perform may be executed by another or plural electronic devices (e.g., the electronic device 1302 or 1304 or the server 1306). According to an embodiment, in the case where the electronic device 1301 executes any function or service automatically or in response to a request, the electronic device 1301 may not perform the function or the service internally, but, alternatively additionally, it may request at least a portion of a function associated with the electronic device 1301 from another device (e.g., the electronic device 1302 or 1304 or the server 1306). The other electronic device (e.g., the electronic device 1302 or 1304 or the server 1306) may execute the requested function or additional function and may transmit the execution result to the electronic device 1301. The electronic device 1301 may provide the requested function or service using the received result or may additionally process the received result to provide the requested function or service. To this end, for example, cloud computing, distributed computing, or client-server computing may be used.

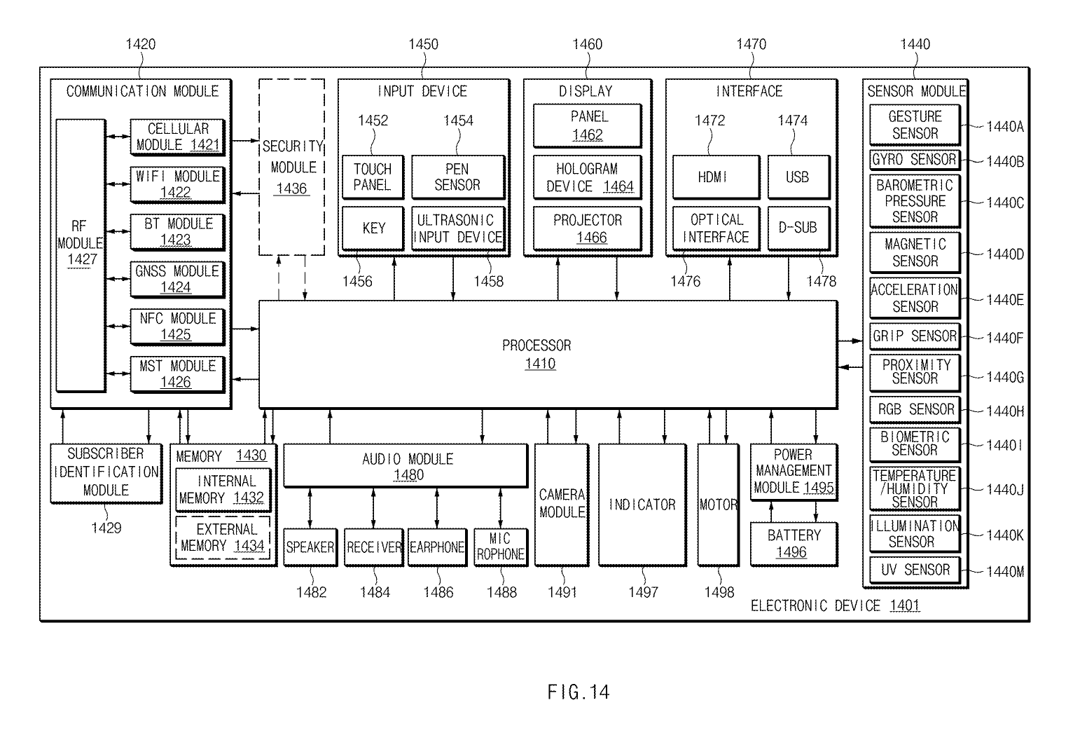

FIG. 14 is a block diagram showing an electronic device according to various embodiments.

The electronic device 1401 may include, for example, all or a part of the electronic device 1301 illustrated in FIG. 13. The electronic device 1401 may include one or more processors (e.g., an application processor (AP)) 1410, a communication module 1420, a subscriber identification module 1429, a memory 1430, a sensor module 1440, an input device 1450, a display 1460, an interface 1470, an audio module 1480, a camera module 1491, a power management module 1495, a battery 1496, an indicator 1497, and a motor 1498. Additionally, the electronic device 1401 may further include a security module 1436. The security module 1436 may include a storage space for storing at least one of data or a program, which are associated with the security function operation and a security function operation processor for controlling data and program operation associated with the security function operation. The security function operation processor may process or transmit data associated with the security function operation of the electronic device 1401.

The processor 1410 may drive, for example, an operating system (OS) or an application to control a plurality of hardware or software components connected to the processor 1410 and may process and compute a variety of data. For example, the processor 1410 may be implemented with a System on Chip (SoC). According to an embodiment, the processor 1410 may further include a graphic processing unit (GPU) and/or an image signal processor. The processor 1410 may include at least a part (e.g., a cellular module 1421) of components illustrated in FIG. 14. The processor 1410 may load a command or data, which is received from at least one of other components (e.g., a nonvolatile memory), into a volatile memory and process the loaded command or data. The processor 1410 may store result data in the nonvolatile memory.

The communication module 1420 (e.g., the communication interface 1370) may be configured the same as or similar to the communication interface 1370 of FIG. 13. The communication module 1420 may include the cellular module 1421, a WiFi module 1422, a Bluetooth (BT) module 1423, a GNSS module 1424, a near field communication (NFC) module 1425, a MST module 1426 and a radio frequency (RF) module 1427. The cellular module 1421 may provide, for example, voice communication, video communication, a character service, an Internet service, or the like over a communication network. According to an embodiment, the cellular module 1421 may perform discrimination and authentication of the electronic device 1401 within a communication network by using the subscriber identification module (e.g., a SIM card) 1429. According to an embodiment, the cellular module 1421 may perform at least a portion of functions that the processor 1410 provides. According to an embodiment, the cellular module 1421 may include a communication processor (CP). According to an embodiment, at least a part (e.g., two or more) of the cellular module 1421, the Wi-Fi module 1422, the BT module 1423, the GNSS module 1424, the NFC module 1425, or the MST module 1426 may be included within one Integrated Circuit (IC) or an IC package. For example, the RF module 1427 may transmit and receive a communication signal (e.g., an RF signal). For example, the RF module 1427 may include a transceiver, a power amplifier module (PAM), a frequency filter, a low noise amplifier (LNA), an antenna, or the like. According to another embodiment, at least one of the cellular module 1421, the WiFi module 1422, the BT module 1423, the GNSS module 1424, the NFC module 1425, or the MST module 1426 may transmit and receive an RF signal through a separate RF module. The subscriber identification module 1429 may include, for example, a card or embedded SIM that includes a subscriber identification module and may include unique identify information (e.g., integrated circuit card identifier (ICCID)) or subscriber information (e.g., integrated mobile subscriber identity (IMSI)).

The memory 1430 (e.g., the memory 1330) may include an internal memory 1432 or an external memory 1434. For example, the internal memory 1432 may include at least one of a volatile memory (e.g., a dynamic random access memory (DRAM), a static RAM (SRAM), a synchronous DRAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), or the like), a hard drive, or a solid state drive (SSD). The external memory 1434 may include a flash drive such as compact flash (CF), secure digital (SD), micro secure digital (Micro-SD), mini secure digital (Mini-SD), extreme digital (xD), a multimedia card (MMC), a memory stick, or the like. The external memory 1434 may be operatively and/or physically connected to the electronic device 1401 through various interfaces.

The sensor module 1440 may measure, for example, a physical quantity or may detect an operation state of the electronic device 1401. The sensor module 1440 may convert the measured or detected information to an electric signal. For example, the sensor module 1440 may include at least one of a gesture sensor 1440A, a gyro sensor 1440B, a barometric pressure sensor 1440C, a magnetic sensor 1440D, an acceleration sensor 1440E, a grip sensor 1440F, the proximity sensor 1440G, a color sensor 1440H (e.g., red, green, blue (RGB) sensor), a biometric sensor 1440I, a temperature/humidity sensor 1440J, an illuminance sensor 1440K, or an UV sensor 1440M. Although not illustrated, additionally or alternatively, the sensor module 1440 may further include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 1440 may further include a control circuit for controlling at least one or more sensors included therein. According to an embodiment, the electronic device 1401 may further include a processor that is a part of the processor 1410 or independent of the processor 1410 and is configured to control the sensor module 1440. The processor may control the sensor module 1440 while the processor 1410 remains at a sleep state.

The input device 1450 may include, for example, a touch panel 1452, a (digital) pen sensor 1454, a key 1456, or an ultrasonic input unit 1458. For example, the touch panel 1452 may use at least one of capacitive, resistive, infrared and ultrasonic detecting methods. Also, the touch panel 1452 may further include a control circuit. The touch panel 1452 may further include a tactile layer to provide a tactile reaction to a user. The (digital) pen sensor 1454 may be, for example, a part of a touch panel or may include an additional sheet for recognition. The key 1456 may include, for example, a physical button, an optical key, a keypad, or the like. The ultrasonic input device 1458 may detect (or sense) an ultrasonic signal, which is generated from an input device, through a microphone (e.g., a microphone 1488) and may check data corresponding to the detected ultrasonic signal.

The display 1460 (e.g., the display 1360) may include a panel 1462, a hologram device 1464, a projector 1466, and/or a control circuit for controlling the panel 1462, the hologram device 1464, or the projector 1466. The panel 1462 may be implemented, for example, to be flexible, transparent or wearable. The panel 1462 and the touch panel 1452 may be implemented with one or more modules. According to an embodiment, the panel 1462 may include a pressure sensor (or force sensor, interchangeably used hereinafter) that measures the intensity of touch pressure by a user. The pressure sensor may be implemented integrally with the touch panel 1452, or may be implemented as at least one sensor separately from the touch panel 1452. The hologram device 1464 may display a stereoscopic image in a space using a light interference phenomenon. The projector 1466 may project light onto a screen so as to display an image. For example, the screen may be arranged in the inside or the outside of the electronic device 1401. The interface 1470 may include, for example, a high-definition multimedia interface (HDMI) 1472, a universal serial bus (USB) 1474, an optical interface 1476, or a D-subminiature (D-sub) 1478. The interface 1470 may be included, for example, in the communication interface 1370 illustrated in FIG. 13. Additionally or alternatively, the interface 1470 may include, for example, a mobile high definition link (MHL) interface, a SD card/multi-media card (MMC) interface, or an infrared data association (IrDA) standard interface.

The audio module 1480 may convert a sound and an electric signal in dual directions. At least a component of the audio module 1480 may be included, for example, in the input/output interface 1350 illustrated in FIG. 13. The audio module 1480 may process, for example, sound information that is input or output through a speaker 1482, a receiver 1484, an earphone 1486, or the microphone 1488. For example, the camera module 1491 may shoot a still image or a video. According to an embodiment, the camera module 1491 may include at least one or more image sensors (e.g., a front sensor or a rear sensor), a lens, an image signal processor (ISP), or a flash (e.g., an LED or a xenon lamp). The power management module 1495 may manage, for example, power of the electronic device 1401. According to an embodiment, a power management integrated circuit (PMIC), a charger IC, or a battery or fuel gauge may be included in the power management module 1495. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, or a rectifier, and the like. The battery gauge may measure, for example, a remaining capacity of the battery 1496 and a voltage, current or temperature thereof while the battery is charged. The battery 1496 may include, for example, a rechargeable battery and/or a solar battery.

The indicator 1497 may display a specific state of the electronic device 1401 or a part thereof (e.g., the processor 1410), such as a booting state, a message state, a charging state, and the like. The motor 1498 may convert an electrical signal into a mechanical vibration and may generate the following effects: vibration, haptic, and the like. The electronic device 1401 may include a device (e.g., a GPU) for supporting a mobile TV which may process media data according to the standards of digital multimedia broadcasting (DMB), digital video broadcasting (DVB), MediaFlo™, or the like. Each of the above-mentioned components of the electronic device according to various embodiments of the present disclosure may be configured with one or more parts, and the names of the components may be changed according to the type of the electronic device. In various embodiments, the electronic device (e.g. the electronic device 1401) may omit some components, and may further include additional components, or some of the components of the electronic device may be combined with each other so as to form one entity, so that the functions of the components may be performed in the same manner as before the combination.

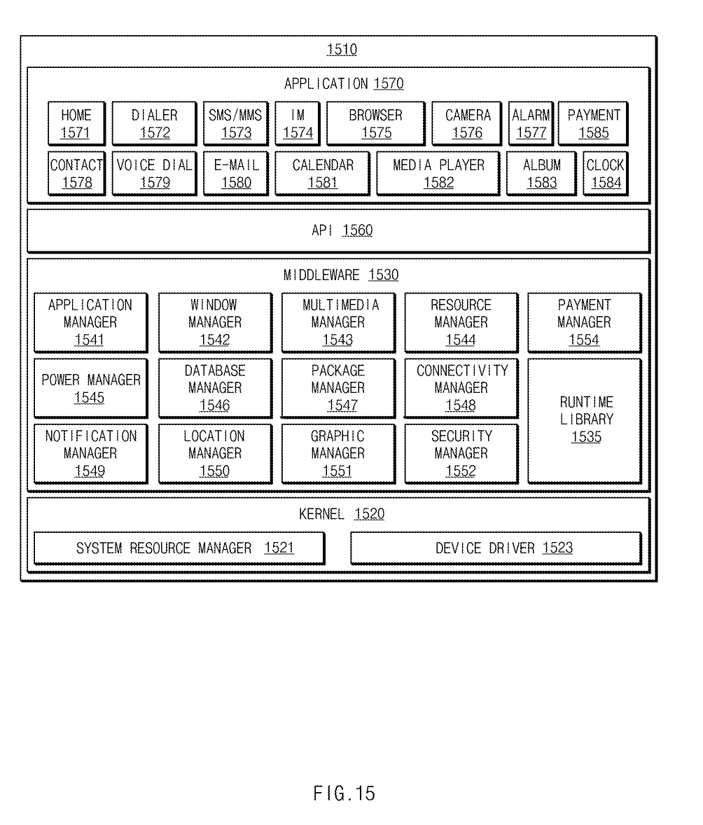

FIG. 15 is a block diagram showing a program module according to various embodiments.

According to an embodiment, a program module 1510 (e.g., the program 1340) may include an operating system (OS) to control resources associated with an electronic device (e.g., the electronic device 1301), and/or diverse applications (e.g., the application program 1347) driven on the OS. The OS may be, for example, Android™ iOS™, Windows™, Symbian™, Tizen™, or Bada™. Referring to FIG. 15, the program module 1510 may include a kernel 1520 (e.g., the kernel 1341), a middleware 1530 (e.g., the middleware 1343), an application programming interface (API) 1560 (e.g., the API 1345), and/or an application 1570 (e.g., the application program 1347). At least a portion of the program module 1510 may be preloaded on an electronic device or may be downloadable from an external electronic device (e.g., the electronic device 1302 or 1304, the server 1306, or the like).

The kernel 1520 may include, for example, a system resource manager 1521 and/or a device driver 1523. The system resource manager 1521 may perform control, allocation, or retrieval of system resources. According to an embodiment, the system resource manager 1521 may include a process managing unit, a memory managing unit, or a file system managing unit. The device driver 1523 may include, for example, a display driver, a camera driver, a Bluetooth driver, a shared memory driver, a USB driver, a keypad driver, a WiFi driver, an audio driver, or an inter-process communication (IPC) driver.

The middleware 1530 may provide, for example, a function that the application 1570 needs in common, or may provide diverse functions to the application 1570 through the API 1560 to allow the application 1570 to efficiently use limited system resources of the electronic device. According to an embodiment, the middleware 1530 (e.g., the middleware 1343) may include at least one of a runtime library 1535, an application manager 1541, a window manager 1542, a multimedia manager 1543, a resource manager 1544, a power manager 1545, a database manager 1546, a package manager 1547, a connectivity manager 1548, a notification manager 1549, a location manager 1550, a graphic manager 1551, a security manager 1552, or a payment manager 1554.

The runtime library 1535 may include, for example, a library module that is used by a compiler to add a new function through a programming language while the application 1570 is being executed. The runtime library 1535 may perform input/output management, memory management, or capacities about arithmetic functions. The application manager 1541 may manage, for example, a life cycle of at least one application of the application 1570. The window manager 1542 may manage a graphic user interface (GUI) resource that is used in a screen. The multimedia manager 1543 may identify a format necessary for playing diverse media files, and may perform encoding or decoding of media files by using a codec suitable for the format. The resource manager 1544 may manage source code of the application 1570 or a space of the memory. The power manager 1545 may manage a battery or power, and may provide power information for an operation of an electronic device. According to an embodiment, the power manager 1545 may operate, for example, with a basic input/output system (BIOS). For example, the database manager 1546 may generate, search for, or modify database that is to be used in the application 1570. The package manager 1547 may install or update an application that is distributed in the form of package file.

The connectivity manager 1548 may manage, for example, wireless connection. For example, the notification manager 1549 may provide a user with an event such as arrival message, appointment, or proximity notification. For example, the location manager 1550 may manage location information about an electronic device. For example, the graphic manager 1551 may manage a graphic effect that is provided to a user, or manage a user interface relevant thereto. For example, the security manager 1552 may provide system security or user authentication. According to an embodiment, the middleware 1530 may include a telephony manager for managing a voice or video call function of the electronic device or a middleware module that combines diverse functions of the above-described components. According to an embodiment, the middleware 1530 may provide a module specialized for each OS. The middleware 1530 may dynamically remove a part of the preexisting components or may add new components thereto. The API 1560 may be, for example, a set of programming functions and may be provided with a configuration that is variable depending on an OS. For example, in the case where an OS is Android™ or iOS™, it may provide one API set per platform. In the case where an OS is Tizen™, it may provide two or more API sets per platform.

The application 1570 (e.g., the application program 1347) may include, for example, one or more applications capable of providing functions for a home 1571, a dialer 1572, an SMS/MMS 1573, an instant message (IM) 1574, a browser 1575, a camera 1576, an alarm 1577, a contact 1578, a voice dial 1579, an e-mail 1580, a calendar 1581, a media player 1582, an album 1583, a watch 1584, an application for providing health care (e.g., measuring an exercise quantity, blood sugar, or the like) or environment information (e.g., information of barometric pressure, humidity, temperature, or the like), or a payment 1585. According to an embodiment, the application 1570 may include an information exchanging application to support information exchange between an electronic device and an external electronic device. The information exchanging application may include, for example, a notification relay application for transmitting specific information to an external electronic device, or a device management application for managing the external electronic device. For example, the notification relay application may include a function of transmitting notification information, which arise from other applications, to an external electronic device, or may receive, for example, notification information from an external electronic device and provide the notification information to a user. The device management application may install, delete, or update, for example, a function (e.g., turn-on/turn-off of an external electronic device itself (or a part) or adjustment of brightness (or resolution) of a display) of the external electronic device which communicates with the electronic device, an application running in the external electronic device. According to an embodiment, the application 1570 may include an application (e.g., a health care application of a mobile medical device) that is assigned in accordance with an attribute of an external electronic device. According to an embodiment, the application 1570 may include an application that is received from an external electronic device. According to various embodiments, at least a portion of the program module 1510 may be implemented by software, firmware, hardware (e.g., the processor 1410), or a combination of two or more thereof and may include modules, programs, routines, sets of instructions, processes, or the like for performing one or more functions.

The term “module” used in the present disclosure may include a unit implemented with hardware, software and firmware. The term “module” may be interchangeably used with the terms “unit”, “logic”, “logical block”, “part” and “circuit”. The “module” may be an integrated part or may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in a computer-readable storage media (e.g., the memory 1330) in the form of a program module. The instruction, when executed by a processor (e.g., the processor 1320), may cause the processor to perform a function corresponding to the instruction. A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and an internal memory. The instructions may contain a code made by a compiler or a code executable by an interpreter.

A module or a program module according to various embodiments may include at least one of the above components, or a part of the above components may be omitted, or additional other components may be further included. Operations performed by a module, a program module, or other components according to various embodiments may be executed sequentially, in parallel, repeatedly, or in a heuristic method. In addition, some operations may be executed in different sequences or may be omitted. Alternatively, other operations may be added.

1. An electronic device comprising:
a panel device outputting a specified image;
an external protective layer having a specified transparency and disposed on the panel device to protect the panel device; and
a case disposed under the external protective layer and receiving the panel device mounted thereon, wherein the external protective layer is provided such that a center portion of an upper portion surface of the external protective layer is located at a higher position than a peripheral portion of the external protective layer, and the panel device includes:
a panel layer outputting the specified image; and
an adhesive layer adhering the panel layer to a lower portion of the external protective layer.

2. The electronic device of claim 1, wherein a black matrix having a constant thickness is disposed between a lower portion of an edge of the external protective layer and the panel device.

3. The electronic device of claim 1, wherein the external protective layer has a convex shape in which a center portion of a lower portion surface of the external protective layer is more protruded than the peripheral portion.

4. The electronic device of claim 3, wherein the external protective layer has a constant thickness.

5. The electronic device of claim 3, wherein a specific portion of the center portion of the external protective layer is formed flat, and a specific portion of the edge of the external protective layer is formed to have a specified curvature.

6. The electronic device of claim 3, wherein the lower portion surface of the external protective layer is formed flat.

7. The electronic device of claim 3, wherein the external protective layer has the shape whose thickness gradually decreases from a center to an edge.

8. The electronic device of claim 3, wherein the panel device is disposed to be convex along the lower portion surface of the external protective layer.

9. The electronic device of claim 8, further comprising:
a power device to supply a power to the electronic device,
wherein the power device includes a battery disposed inside the panel device having the convex shape.

10. The electronic device of claim 9, wherein the power device includes a plurality of batteries electrically connected to each other and having different sizes from each other.

11. The electronic device of claim 8, further comprising:
a lower supporter supporting the panel device such that the panel device is adhered to the lower portion surface of the external protective layer,
wherein the lower supporter includes:
a support adhesive layer adhered to the edge of the external protective layer; and
a support body making contact with the lower portion surface of the panel device and upwardly supporting the panel device such that the panel device is adhered to the external protective layer.

12. The electronic device of claim 11, further comprising an auxiliary layer formed of a flexible material and disposed between the panel device and the lower supporter.

13. The electronic device of claim 8, wherein the panel device includes at least one cut-away portion formed by cutting a border of the panel device.

14. The electronic device of claim 1, further comprising:
a printed circuit board disposed under the panel device and including a hardware mounted thereon and related to a control of the panel device and a processor mounted on the printed circuit board,
wherein the processor is configured to output an image displayed on the panel device after performing a coordinate correction on the image by taking into account a distorted degree due to the external protective layer.

15. The electronic device of claim 1, further comprising a sensor device that collects sensor information related to an operation of the electronic device.
